(19) United States
(12) Patent Application Publication
(10) Pub. No.: US 2018/0345771 A1
(43) Pub. Date: Dec. 6, 2018

(54) Wind Guiding Device for a Motor Vehicle, in Particular a Passenger Motor Vehicle

(71) Applicant: Daimler AG, Stuttgart (DE)

(72) Inventors: Nicolai MELCHGER, Wildberg (DE); Alexander MOESSNER, Rutesheim (DE); Joachim WENZLER, Simmozheim (DE)

(73) Assignee: Daimler AG, Stuttgart (DE)

(21) Appl. No.: 15/778,552

(22) PCT Filed: Nov. 10, 2016
(86) PCT No.: PCT/EP2016/001868

§ 371 Date: May 23, 2018

(30) Foreign Application Priority Data
Nov. 24, 2015 (DE) 102015015206.8

(51) Int. Cl. B60J 7/22; B60J 7/043

(52) U.S. Cl. CPC B60J 7/22; B60J 7/043

(57) ABSTRACT

A wind guiding device of an openable roof of a motor vehicle includes at least one inherently rigid profile which air flows around in at least one position and when the motor vehicle is moving forwards and which has at least one front edge via which the air flows around the profile. A substance surface is arranged in at least one edge region of the profile that is connected to the front edge in the back in the longitudinal direction of the vehicle.

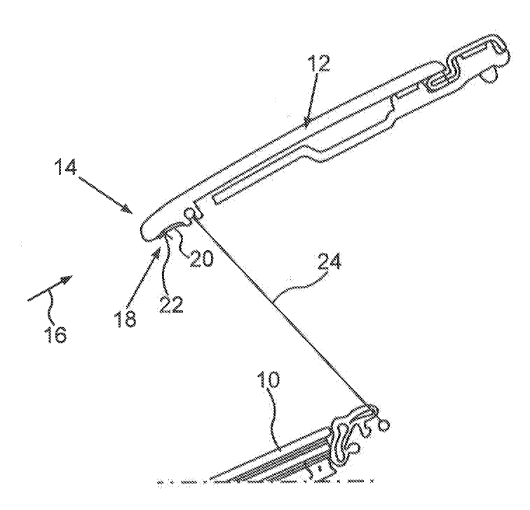

### BACKGROUND AND SUMMARY OF THE INVENTION

The invention relates to a wind guiding device for a motor vehicle, in particular a passenger motor vehicle.

Such a wind guiding device for a motor vehicle, in particular a passenger motor vehicle, is already known from DE 10 2004 027 087 D4, for example. The wind guiding device comprises at least one inherently rigid profile that air flows around when the motor vehicle is travelling forwards in at least one position and is formed as a fin, for example, whose longitudinal extension direction runs at least substantially in the transverse direction of the vehicle and thus transversely to the flow direction of the air. The profile can, for example, be shifted between the at least one position and at least one retracted position in the vertical direction of the vehicle and, here, is arranged further up, for example, in the at least one position relative to the retracted position in the vertical direction of the vehicle.

Here, the profile has at least one front edge via which the air flows along the profile. This means that the front edge is an edge or side pointing forwards in the longitudinal direction of the vehicle, which is in the wind in the at least one position and when the motor vehicle is travelling forwards and, correspondingly, air flows along or flows around it. In the at least one position, the profile is thus a so-called flowed-around profile that air or airstream flows around when the motor vehicle is travelling forwards.

Such profiles that are flowed around in at least one position are also known from serial vehicle production, wherein the respective profile is formed, for example, as a cover of a sliding or tilting roof. Such a cover can be shifted in the vertical direction of the vehicle, for example, and also has a front edge which air or an airstream flows along and flows around in at least one position of the cover and when the motor vehicle is travelling forwards. It has been shown that profiles or covers flowed around on the front edge can result in so-called front edge noise with howling and/or whistling sounds.

The object of the present invention is thus to further develop a wind guiding device of the type mentioned at the start in such a way that particularly advantageous noise behavior can be achieved.

In order to further develop a wind guiding device of the type mentioned at the start in such a way that particularly advantageous noise behavior can be achieved, it is provided according to the invention that a preferably rough substance surface is arranged in at least one edge region of the profile that is connected backwards to the front edge in the longitudinal direction of the vehicle., As a result of the rough substance surface, the flow resistance of the profile is increased without the pressure forces being able to settle on the surface, since a substance forming the substance surface, for example, can be evasive. It has been shown that wind noises, in particular howling and/or whistling sounds, can be avoided or at least kept to a minimum by such a substance surface and its arrangement in the edge region connecting to the front edge, such that particularly advantageous noise behavior of the wind guiding device can be achieved.

The profile is, for example, an inherently rigid fin which extends, for example, at least in the at least one position at least substantially in the transverse direction of the vehicle and thus transversely to the flow direction of the air. Furthermore, it is conceivable that the profile is formed as a cover of a sliding and/or tilting roof, wherein the cover can be shifted, for example, in the vertical direction of the vehicle. Furthermore, it is possible that the profile is a spoiler, which can be adjusted between the at least one position and at least one retracted position, for example. Furthermore, it is possible that the profile is formed as a wind deflector or wind deflector wing, by means of which the air can be guided or deflected.

The invention is based on the recognition that, with conventional flowed-around profiles on the front edge, the result can be front edge noise with howling and/or whistling sounds. The causes of this are temporally fluctuating pressure differences on the upper and lower side of the profile, in particular its profile tip, whereby compensation flows emerge that, in turn, influence the pressures. By using the substance surface, with the wind guiding device according to the invention, the compensation flows and thus those with howling and/or whistling sounds can be reduced, such that excessive front edge noise can be avoided.

Further advantages, features and details of the invention arise from the description of a preferred exemplary embodiment below, as well as with the aid of the drawing.

### BRIEF DESCRIPTION OF THE DRAWING

The Figure shows, in a schematic longitudinal section view, a wind guiding device for a motor vehicle, in particular a passenger motor vehicle.

### DETAILED DESCRIPTION OF THE DRAWING

The passenger motor vehicle is formed, for example, as an open passenger motor vehicle, and here has a cover which can be shifted relative to the body of the passenger motor vehicle between a closed position and at least one open position. Here, the wind guiding device is held, for example, on a windscreen frame of the passenger motor vehicle. A pane opening is bordered by the windscreen frame, a windscreen 10 of the passenger motor vehicle that can be recognized in sections in the Figure being arranged in the pane opening. Here, the windscreen 10 is held on the windscreen frame.

Furthermore, it is conceivable that the wind guiding device is arranged in a front edge region in the longitudinal direction of the vehicle of a roof opening formed as a through opening of a roof of the body of the passenger motor vehicle. The wind guiding device here comprises at least one inherently rigid profile 12 which can presently be adjusted between at least one wind guiding position shown in the Figure and at least one retracted position. In particular, the profile 12 can be moved relative to the windscreen frame between the wind guiding position and the retracted position. In the wind guiding position, the profile 12 is arranged further up in the vertical direction of the vehicle in comparison to the retracted position. Presently, the profile 12 is formed as an inherently stiff fin whose longitudinal extension direction runs at least substantially in the transverse direction of the vehicle. However, the profile 12 could also be formed as a wind deflector wing, spoiler or cover of a sliding and/or tilting roof.

If the profile 12 is in the wind guiding position, then an airstream flows along and flows around the profile 12 when the motor vehicle is driving forwards. This means that the profile 12 is in the wind at least in the wind guiding position. Here, the profile 12 formed from a plastic material, for example, has a front edge 14 which points forwards in the longitudinal direction of the vehicle. In the wind guiding position and when the motor vehicle is travelling forwards, the air flowing around the profile 12 flows along the profile 12 via the front edge 14. This flow is illustrated in the Figure by an arrow 16.

In order to now achieve particularly advantageous noise behavior of the wind guiding device, a rough substance surface 20 is provided in at least one edge region 18 of the profile 12 connecting backwards to the front edge 14 in the longitudinal direction of the vehicle, the substance surface 20 being formed by a flocking, i.e., as flock. Alternatively, it is conceivable that the substance surface 20 is formed by a substance strip, in particular a fibrous substance strip, In other words, the rough substance surface 20 is formed by a substance which is arranged, in particular fixed, on the profile 12. From the Figure it emerges that the substance surface 20 is presently arranged on an underside 22 of the profile 12 pointing downwards in the vertical direction of the vehicle.

In the exemplary embodiment depicted in the Figure, the front edge 14 is rounded off and thus has a curved course—when seen in perpendicular to the air flow 16. The underside 22 of the profile 12 having the substance surface 20 connects seamlessly to the front edge 14. Here, this wall region having the substance surface 20 is formed to be curved and indeed here, to be concavely curved—starting from the windscreen upper side.

The profile 12 is a profile that air flows around, at least in the wind guiding position and when the passenger motor vehicle is travelling forwards, in which—if corresponding countermeasures are not met—it can result in howling and/or whistling sounds on the front edge 14. A countermeasure against the emergence of howling and/or whistling sounds is the substance surface 20, by means of which the emergence of unwanted wind noises can be avoided or at least kept to a minimum.

The wind guiding device further comprises a flexible and air-permeable surface element 24 that is connected to the profile 12 and is formed as a net, for example. The surface element 24 is, on the one hand, connected to the profile 12 and, on the other hand, at least directly to the windscreen frame, for example, wherein the surface element 24 can be adjusted together with the profile 12. Thus, the surface element 24 is spanned between the profile 12 and the windscreen frame in the wind guiding position—as can be seen in the Figure. Unpleasant noises, in particular humming noises, and/or unwanted air flows into the passenger compartment of the passenger motor vehicle can be avoided or at least kept to a minimum by means of the surface element 24, in particular when the cover or the sliding and/or tilting roof is open.

As is apparent in the Figure, the concavely curved wall region of the profile underside 22 provided with the substance surface 20 is arranged relative to the spanned surface element 24 in such a way that the air flowing along the front edge 14 is deflected or guided by means of this wall region of the profile underside 22 in the direction of the surface element, such that the air flow flowing near to or above the profile underside 22 directly hits the surface element 24 and does not collide with the fixing point of the surface element 24 that is provided effectively in extension of the substance surface on the profile 12, which could lead to unwanted disturbances of the air flow.

1.-6. (canceled)

7. A wind guiding device of an operable roof of a motor vehicle, comprising:
a rigid profile, Wherein air is flowable around the rigid profile in a wind guiding position of the rigid profile when the motor vehicle is travelling in a forward direction and Wherein the rigid profile has a front edge via which the air is flowable around the rigid profile; and
a substance surface, wherein the substance surface is disposed in an edge region of the rigid profile connecting backwards to the front edge in a longitudinal direction of the motor vehicle.

8. The wind guiding device according to claim 7, wherein the substance surface is disposed on an underside of the rigid profile pointing downwards in a vertical direction of the motor vehicle.

9. The wind guiding device according to claim 7, wherein the substance surface is formed by a flocking.

10. The wind guiding device according to claim 7, wherein the substance surface is formed by a substance strip.

11. The wind guiding device according to claim 10, wherein the substance strip is a fibrous substance strip.

12. The wind guiding device according to claim 7, wherein the rigid profile is adjustable between a retracted position and the wind guiding position and wherein in the wind guiding position the rigid profile is disposed further up relative to the retracted position in a vertical direction of the motor vehicle.

13. The wind guiding device according to claim 7 further comprising a flexible surface element that is connected to the rigid profile and is adjustable together with the rigid profile.
